(19) United States
(12) Patent Application Publication
(10) Pub. No.: US 2014/0349724 A1
(43) Pub. Date: Nov. 27, 2014

(54) DYNAMIC VIDEO GAMES FOR TRAINING SENSORY AND PERCEPTUAL SKILLS

(71) Applicant: CARROT NEUROTECHNOLOGY, INC., Calabasas,, CA (US)

(72) Inventors: AARON SEITZ, CALABASAS, CA (US); ADAM GOLDBERG, CALABASAS, CA (US); STEVE GANEM, CALABASAS, CA (US); SIMON MATTHEW, CALABASAS, CA (US)

(73) Assignee: CARROT NEUROTECHNOLOGY, INC., Calabasas, CA (US)

(21) Appl. No.: 14/286,938

(22) Filed: May 23, 2014

Related U.S. Application Data
(60) Provisional application No. 61/826,966, filed on May 23, 2013.

(51) Int. Cl. G09B 5/02; A63F 13/822

(52) U.S. Cl. CPC G09B 5/02; A63F 13/822
USPC 463/9

(57) ABSTRACT

A system and method of providing adaptive training sessions for visual perception provides long-term training schedules, each schedule composed of visual training sessions, each training session composed of training exercises. Each training session is gamified by keeping score related to user input regarding Gabor patches, distractors, and other visual stimuli. Furthermore, each training session is adapted to the user based on user input in each training exercise, and the long-term schedule is adapted to the user based on data collected about the user during each training session.

### CLAIM OF PRIORITY

This applications claims priority to provisional application No. 61/826,966 filed on May 23, 2013, and hereby incorporated by reference.

### BACKGROUND OF INVENTION

1. Field of the Invention: The present invention relates to training software and programs, and more specifically, training software for improvement of acuity and perception of vision.

2. General Background and State of the Art

Over the last half-century, the study of perceptual learning has proven to be increasingly valuable. Enhanced perceptual abilities can benefit almost all aspects of our lives; such as improved visual-motor skills, improved surgical skills, improved reading skills, etc. Currently there are many studies that demonstrate improvements of a wide range of perceptual abilities. However, while the existence and benefits of perceptual learning is clear, the processes by which it can be acquired are not. Training on a perceptual task does not always result in perceptual improvements and in many cases weeks or more of training are required to obtain significant perceptual improvements. Of note, recent research has demonstrated playing action video games leads to enhanced attention and perceptual improvements.

In particular, existing video games intended to train for improvement of acuity and perception of sight have generally used very simple yes/no interfaces that do not allow for in-depth testing of sight with relation to multiple variables, such as size, contrast, orientation, pattern complexity, location, or audio stimulation.

Newer visual acuity software incorporates gamification to improve perceptual learning. See, e.g. U.S. patent application Ser. No. 13/276,529, the entirety of which is incorporated by reference. However, no invention has combined adaptive visual training exercises, gamification, and a long-term training schedule adaptively customized by users' inputs to produce an optimum training regimen.

### INVENTION SUMMARY

The invention groups methodologies of task-irrelevant learning (TIL) and multisensory facilitation (MF) with video game elements to function as a software-based method of improving a user's senses through the use of a series of sensory-training exercises. These exercises may be taken one-at-a-time, or, preferably, as part of a scheduled training regimen. These exercises may rely on Gabor patches, Landolt C designs, or any other designs traditionally used to study or improve eyesight. In one embodiment, a human coach may set a long-term training and difficulty schedule for a user, and an algorithm within the invention may adjust the short-term difficulty of the individual exercises. In alternative embodiments, a human coach may guide both of these, or the algorithm may control both of these, or both may be controlled by some combination of the input of a human coach and the input of an algorithm. After some time of performing these exercises, the invention improves the perception and acuity of the user's senses.

Many systems or apparatus of providing visual training exercises are well known in the art. For example, U.S. patent application Ser. No. 09/711,354; U.S. Pat. No. 7,427,138; U.S. Pat. No. 6,876,758 (each incorporated by reference) disclose systems and apparatuses for improving vision using multiple sets of images for testing and treatment, and computer processors, storage, display and input devices. The present invention may be performed with any of these systems or apparatuses, or, in a preferred embodiment, using the systems described below.

The invention incorporates approaches proven to boost learning, such as multisensory stimuli, motivating tasks, and the use consistent reinforcement and variance of training stimuli when participants are confident in their performance. These are included within an intuitive video game style interface. The addition of video game style interfaces leverage people's natural desires for competition, achievement, status, self-expression, altruism, and closure. Adding video game style interfaces to traditional learning exercises has been shown to significantly improve participation, feedback, data quality, and learning.

The invention is proven to treat and improve the vision of users suffering from amblyopia, nearsightedness, farsightedness, and decrease of vision due to cataracts. It also improves vision in otherwise healthy users who may benefit from enhanced vision, such as athletes, surgeons, artists, or engineers. Studies have shown that after a regimen using the invention, an average user can read an additional one or two rows of letters on a traditional Snellen visual acuity test.

The invention incorporates long-term scheduling of training exercises to optimize the improvement of users' vision. Research has shown that customizing training sessions' by length, frequency, difficulty, the types of training exercises, and other scheduling parameters improve users' vision more quickly than uncustomized training sessions. The present invention allows each training session to be customized by altering training parameters, either algorithmically, or by a human instructor interacting with the invention.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 depicts an embodiment of a static Gabor patch exercise, wherein Gabor patches appear in groups.

FIG. 2 depicts the same embodiment of a static Gabor patch exercise, wherein the user has interacted with several of the Gabor patches.

FIG. 3 depicts the same embodiment of a static Gabor patch exercise, wherein the Gabor patches are of increased internal pattern frequency.

FIG. 4 depicts the same embodiment of a static Gabor patch exercise, where distracters in the form of single-shade shapes are included.

FIG. 5 depicts the same embodiment of a static Gabor patch exercise, where distracters in the form of multi-shade shapes are included.

FIG. 6 depicts the same embodiment of a static Gabor patch exercise, where distracters in the form of other Gabor patches are included.

FIG. 7 depicts an embodiment of a dynamic Gabor patch exercise, wherein Gabor patches appear gradually as time passes.

FIG. 8 depicts an embodiment of a dynamic Gabor patch exercise, wherein Gabor patches appear gradually as time passes, and wherein the user has interacted with several of the Gabor patches, and received a multiplier award.

FIG. 9 depicts an embodiment of a Landolt C assessment test, wherein a user is' instructed to interact with the invention based on the direction that a Landolt C design is rotated.

FIG. 10 depicts the same embodiment of a Landolt C assessment test, wherein the Landolt C design has faded.

FIG. 11 depicts the same embodiment of a Landolt C assessment test, wherein the Landolt C design has been reduced.

FIG. 12 depicts an embodiment of a Gabor patch Contrast Sensitivity Function test, wherein a user is instructed to interact with the invention based on matching a Gabor patch pattern.

FIG. 13 depicts the same embodiment of a Gabor patch Contrast Sensitivity Function test, wherein the center Gabor patch has faded.

FIG. 14 depicts the same embodiment of a Gabor patch Contrast Sensitivity Function test, wherein the center Gabor patch has an increased frequency.

FIG. 15 depicts a flow chart illustrating one embodiment of the invention.

### DETAILED DESCRIPTION OF THE INVENTION

The invention functions as a software-based method of improving a user's eyesight through the use of a series of sensory-training exercises. These exercises may be taken one-at-a-time, or, preferably, as part of a scheduled training regimen. The schedule may be set by human coaches or by a computerized algorithm. The long-term schedule may be adjusted during the scheduled training regimen by human coaches or by a computerized algorithm. The short-term difficulty of individual exercises may also be adjusted during the scheduled training regimen by human coaches or by a computerized adaptive algorithm using training parameters to set training exercises appropriate to challenge and improve the users' eyesight. The parameters that may be changed by the adaptive algorithm include, but are not limited to, attributes of targets (size, orientation, spatial frequency, contrast, timing, adaptive parameters), attributes of distracters (type, size, contrast, number, flicker), level type (static, dynamic), description, instructions, help text, passing criteria, number of repetitions, duration, and game play characteristics (teleporting or disappearing objects). Notably, the present invention is capable of dynamically modifying multiple training parameters at the same time, including during a training exercise, training session., or afterwards when setting a long-term schedule. The adaptive algorithm may change the parameters in between training exercises depending on a user's performance, to select parameters that are challenging to the user, and thus improve eyesight, as is well known in the art.

The invention includes software for customizing the schedule. The invention allows customization of training session and long-term schedule parameters by a coach, clinician or end-user including but not limited to, attributes of targets (size, orientation, spatial frequency, contrast, timing, adaptive parameters), attributes of distracters (type, size, contrast, number, flicker), level type (static, dynamic), description, instructions, help text, passing criteria, number of repetitions, duration, and game play characteristics (teleporting or disappearing objects). Multiple parameters may be modified simultaneously for training sessions and long-term schedules.

In several embodiments, the invention may display multiple patterns to the user. These patterns may be Gabor patches, high-contrast shape patterns, alphanumeric characters, symbols, hieroglyphs, other patterns whose contrast can be adjustably high or low, or other patterns that can otherwise be used to test eyesight. These patterns are herein collectively referred to simply as “Gabor patches”.

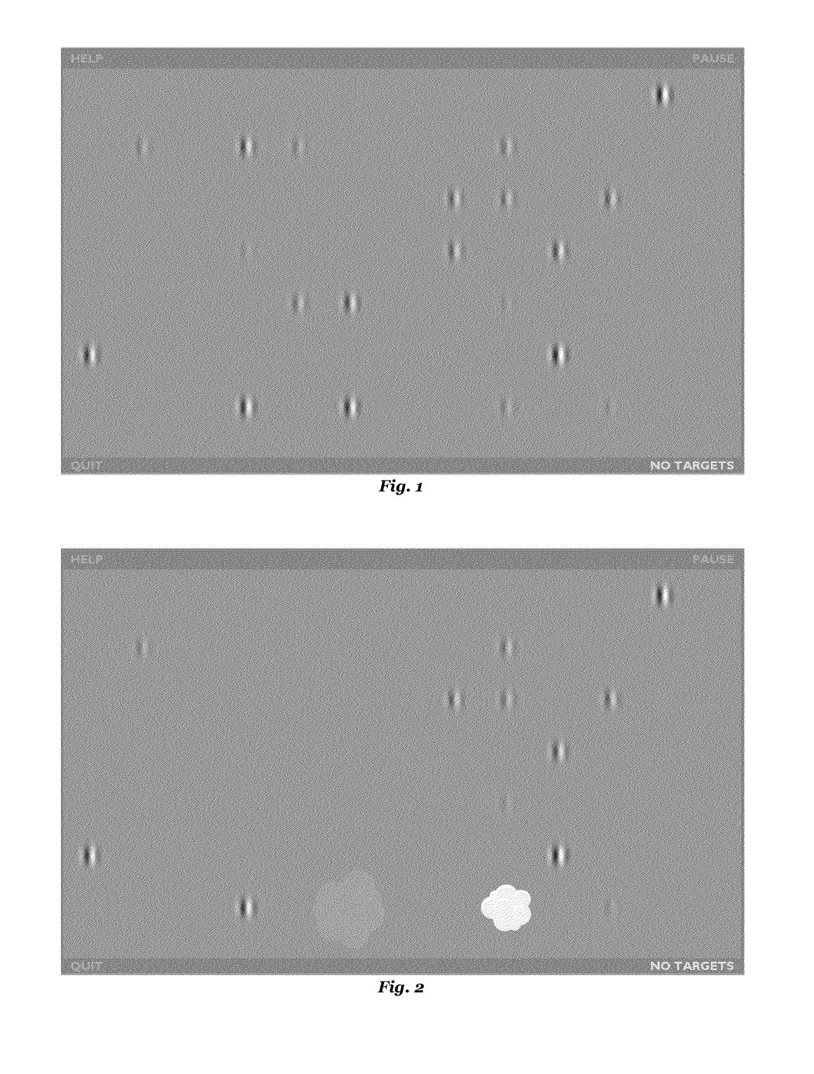

One embodiment of this invention uses a static Gabor patch exercise to enhance sensory perception. FIGS. 1-5 show depictions of this embodiment. In such an exercise, a plurality of Gabor patches are displayed simultaneously on a grey background. A user may be rewarded or punished based on how quickly the patches are all visually found and selected through a selection interaction with the software. This selection interaction may be a mouse click, if the invention is being used on a computer set up to use a mouse. It may also be a touch on a touch screen, or on a track pad. It may also be an interaction using a pointer device. It may also be an interaction with a camera facing the user that is able to detect a user pointing to or otherwise selecting an area of a display screen.

FIG. 1 shows a depiction of a static Gabor patch exercise in an initial state. Multiple Gabor patches are pictured. The contrast levels may vary between different Gabor patches, as depicted. In alternative embodiments, these Gabor patches may also vary in at least one of: size, internal pattern frequency, and orientation.

FIG. 2 shows a depiction of the static Gabor patch exercise of FIG. 1 after several user interactions. A visual cue, such as an animated cloud of smoke, may be used to indicate selection of a particular Gabor patch. An audio cue may also be used, which may use stereo or 3d audio to indicate the location of the Gabor patch, and may additionally vary in pitch based on the location of a Gabor patch. For example, an audio cue may be higher pitched if the Gabor patch was located higher up on the screen, and may use primarily the left speaker of a stereo system if the Gabor patch is located near the left side of the screen.

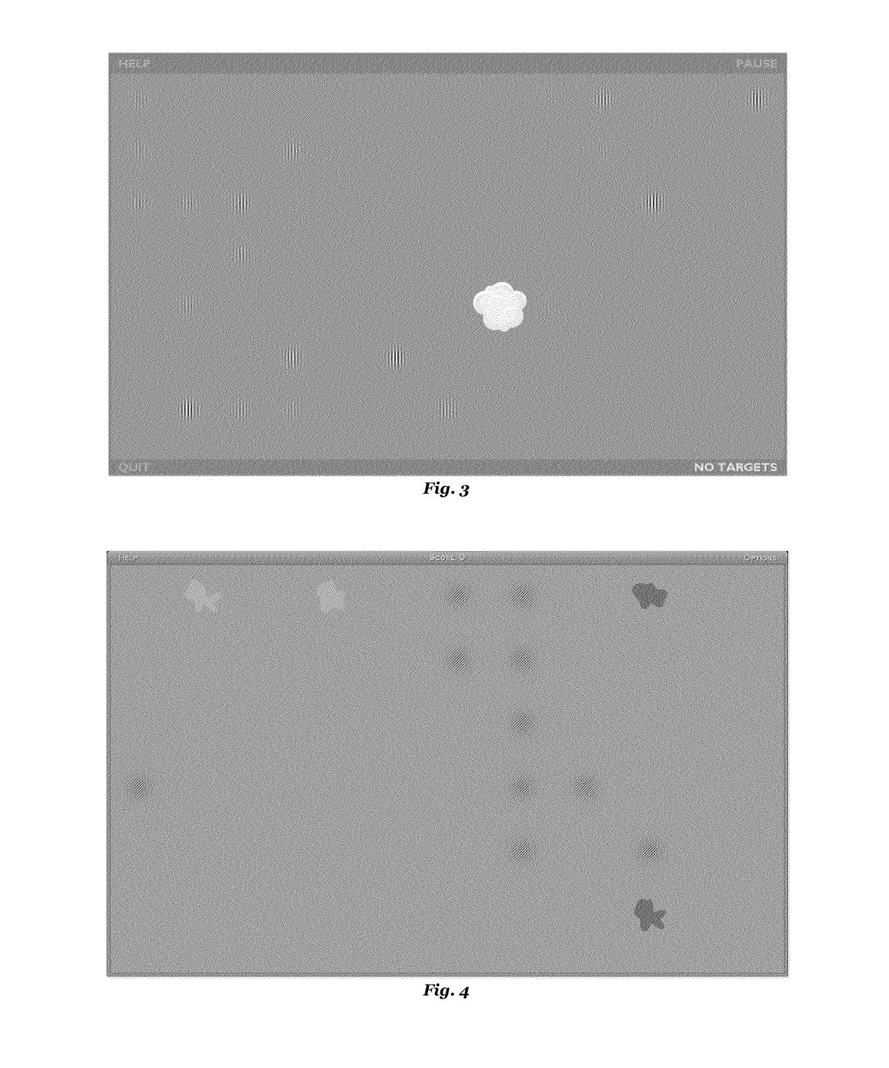

FIG. 3 shows a depiction of a static Gabor patch exercise with a user interacting, as in FIG. 2. FIG. 3, however, displays Gabor patches with higher internal pattern frequencies. Higher internal pattern frequencies of the Gabor patches are one method of increasing the difficulty of such an exercise, because these are more difficult for the eye to see. Other variables that the invention may vary to adjust difficulty may include at least one of: size, contrast level, and orientation.

FIG. 4 shows a depiction of a static Gabor patch exercise with a user interacting and a high internal Gabor patch frequency, as in FIG. 3. FIG. 4, however, also includes distracters. Distracters are elements that appear onscreen with the Gabor patches that the user is meant to select, but that are not the Gabor patches that the user is meant to select. If a user selects a distracter, the software may penalize the user. The software may also adjust the short-term difficulty of the tests, or even the user's long-term training schedule in response to the user's selection of distracters. In an alternative embodiment, a human coach may control some of these short-term difficulty or long-term scheduling adjustments. In FIG. 4, these distracters are depicted as irregular shapes in a uniform shade of grey. Distracters can take any form that is capable of being displayed on a screen and that is different from the Gabor patches the user is meant to select.

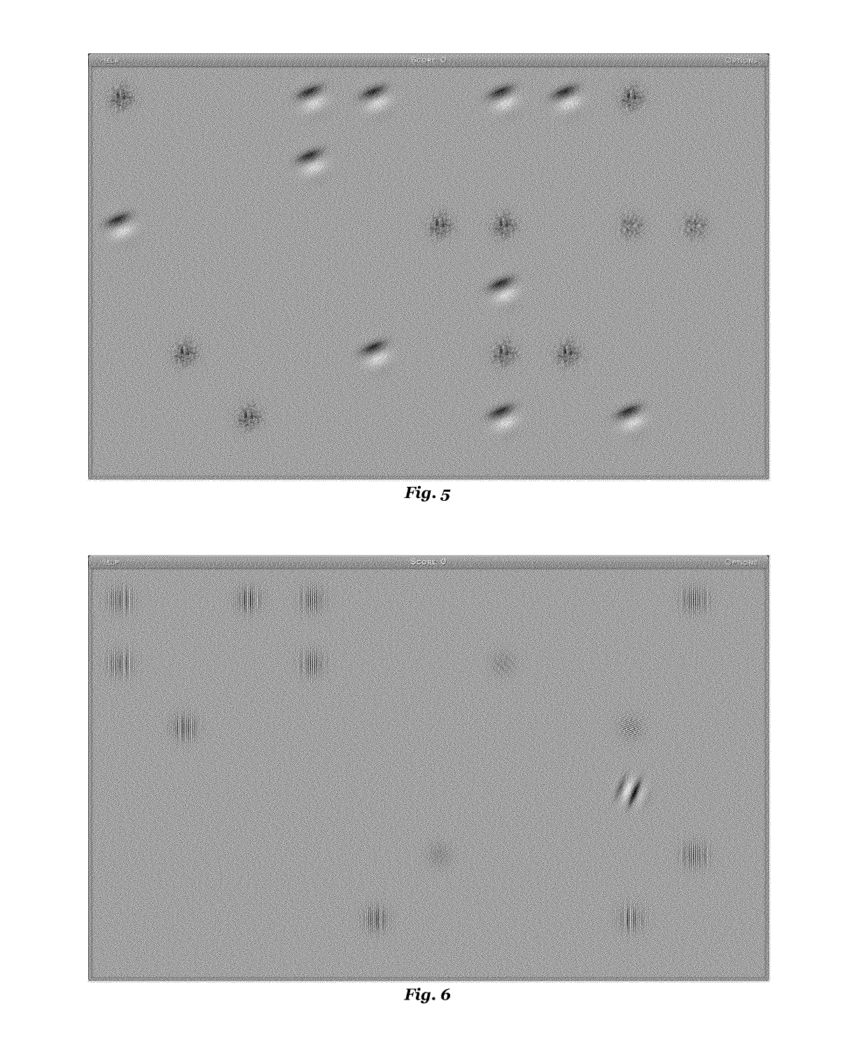

FIG. 5 also shows a depiction of a static Gabor patch exercise with a user interacting and a high internal Gabor patch frequency, as in FIG. 4. In FIG. 5, however, the distracters are depicted as multi-shade garbled patches.

FIG. 6 also shows a depiction of a static Gabor patch exercise with a user interacting and a high internal Gabor patch frequency, as in FIGS. 4 and 5. In FIG. 6, however, the distracters are depicted as Gabor patches of different sizes, internal pattern frequencies, and orientations than the Gabor patches that the user is meant to select.

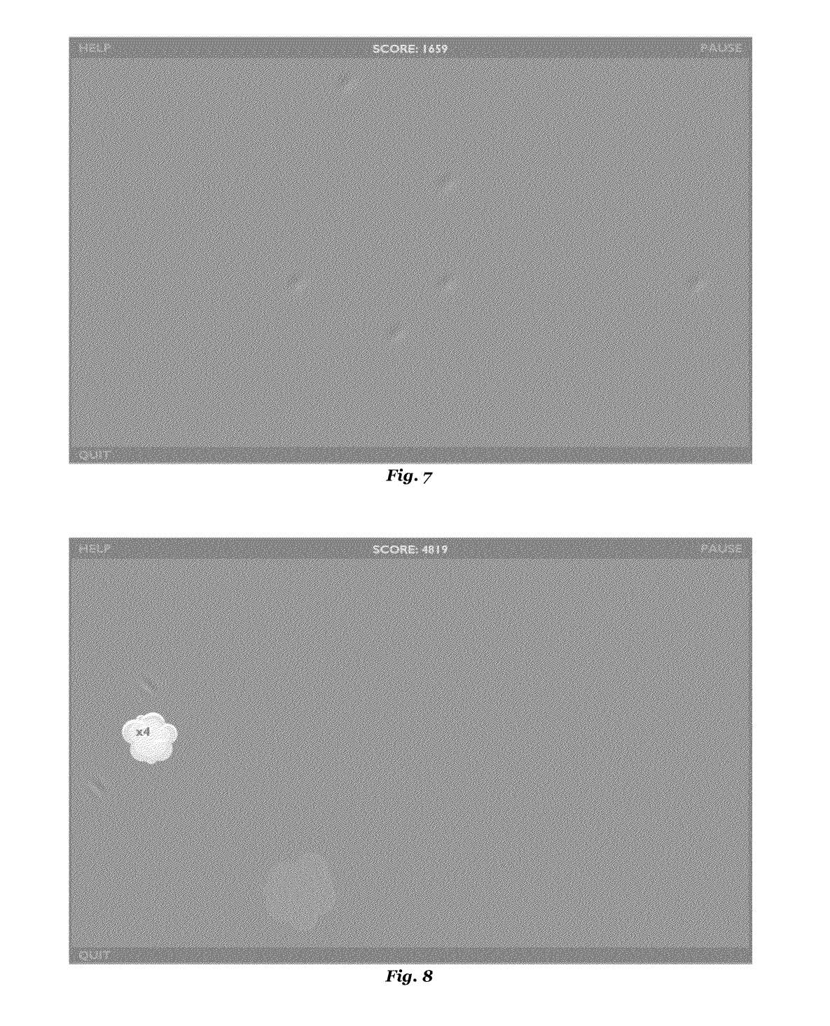

FIG. 7 shows a depiction of a dynamic Gabor patch exercise, wherein Gabor patches appear gradually as time goes on. The Gabor patches may appear one at a time, or may alternately appear in groups. In this depiction, several Gabor patches have already appeared on the screen, and the user has not yet selected them.

FIG. 8 shows a depiction of the dynamic Gabor patch exercise of FIG. 7 after several user interactions. FIG. 8 further depicts a score multiplier, which the software may use in order to reward the user for quick selection of a Gabor patch. The time that a user takes to select a Gabor patch may also be used to adjust the short-term difficulty of the tests, or even the user's long-term training schedule. If a user takes a predetermined amount of time before selecting a Gabor patch, the software may animate the Gabor patch to alert the user to the location of the patch. This animation may include inverting the shades of grey of the Gabor patch, circling the Gabor patch, adjusting the contrast level of the Gabor patch, adjusting the size of the Gabor patch, adjusting the location of the Gabor patch, or any other animation that may draw a user's attention to the Gabor patch in question. The software may also provide an auditory cue after a predetermined time. This predetermined time may be the same as the time for the animation, or it may be different. The auditory cue may use stereo or 3d audio to indicate the location of the Gabor patch, and may additionally vary in pitch based on the location of a Gabor patch. For example, an audio cue may be higher pitched if the Gabor patch was located higher up on the screen, and may use primarily the left speaker of a stereo system if the Gabor patch is located near the left side of the screen.

Thus, the present invention differs from the prior art because it randomly assigns Gabor patches and distractors and tracks the speed with which a user interacts with them in order to create a game out of the training exercise and session.

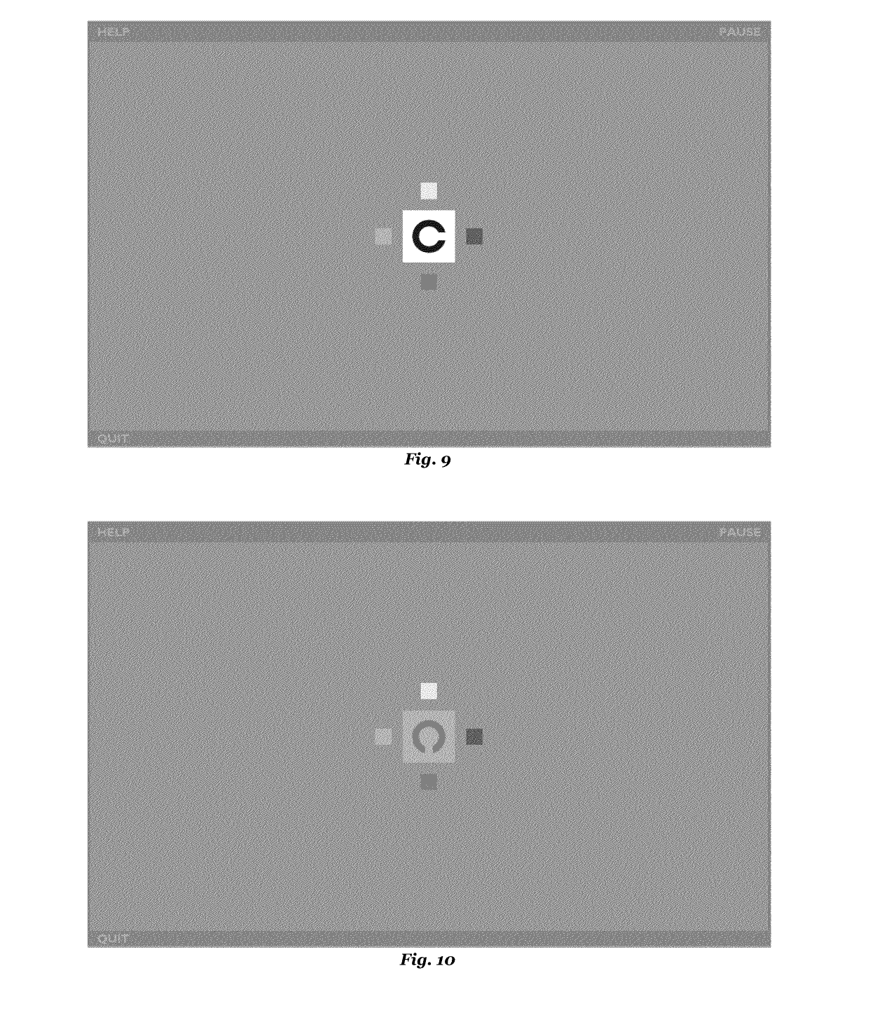

FIG. 9 shows a depiction of a Landolt C assessment exercise in an initial state. In such an exercise, a design resembling a letter C is depicted in a contrasting rectangle. In an alternative embodiment, this C design could be replaced by any shape that can be perceived as pointing in a specific direction. Such a test may require a user to indicate, by selection, which direction this C design is facing. After each interaction, the software may change the direction that the C design is pointing.

FIG. 10 shows a depiction of the Landolt C assessment exercise of FIG. 9 after several user interactions. After several user interactions, the exercise may step up the difficulty of the test. One method of stepping up the difficulty of the test, as depicted in FIG. 10, is to adjust the contrast of the C design. In an alternative embodiment, the invention might adjust the size of the C design for this purpose instead.

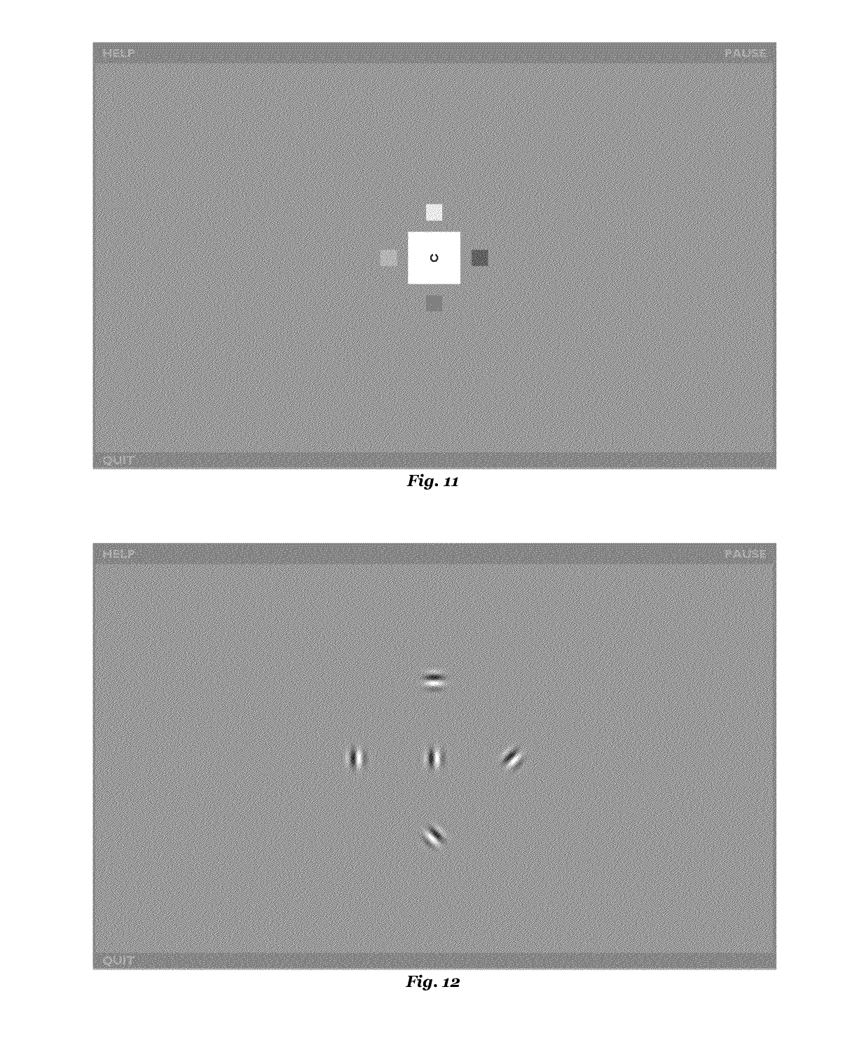

FIG. 11 shows a depiction of the Landolt C assessment exercise of FIGS. 9 and 10 after several incorrect user interactions. After several incorrect user interactions, the exercise may adjust its approach toward the user. One method of adjusting its approach, as depicted in FIG. 11, is to reset the contrast back to its highest point, but to decrease the size of the C design. Through multiple iterations of such testing, the software used by the invention may adapt to the limits of the user's senses regarding both contrast and size perception. In an alternative embodiment, the exercise may adjust its approach after several incorrect inputs by increasing the size, but lowering the contrast, or by resetting the contrast without adjusting the size, or by resetting the size without adjusting the contrast.

FIG. 12 shows a depiction of a Gabor patch Contrast Sensitivity Function exercise in an initial state. In such an exercise, a user's interactions should be based on matching a single Gabor patch pattern to one of several other Gabor patches. In the embodiment pictured, the central Gabor patch must be matched by the user with one of four differently oriented Gabor patches located on each side of the central Gabor patch. These Gabor patches may be arranged in any way wherein the Gabor patch to be matched may be differentiated from the other Gabor patches that it must be match against. An alternative embodiment may use any predetermined number of Gabor patches, and they need not all be differently arranged. In addition to orientation differences the Gabor patches may further vary in at least one of: contrast level, size, and internal pattern frequency.

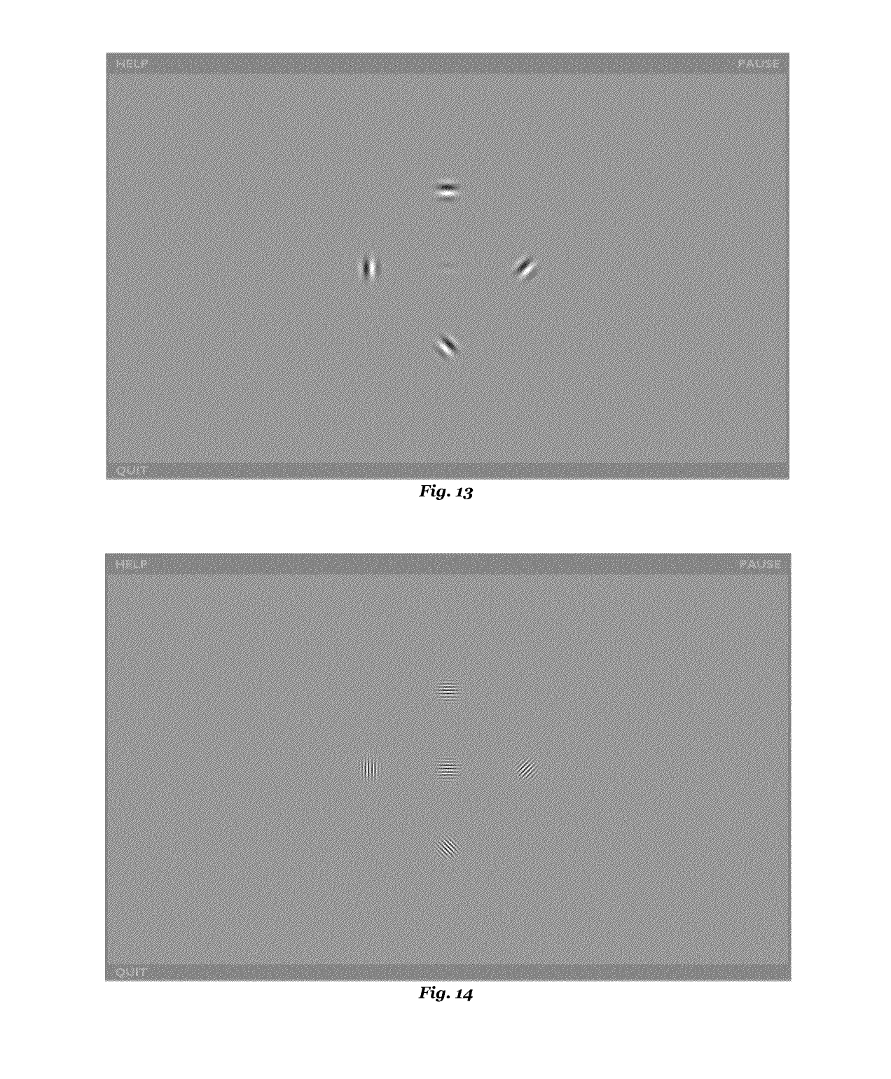

FIG. 13 shows a depiction of the Gabor patch Contrast Sensitivity Function exercise of FIG. 12 after several user interactions. The central Gabor patch is differently oriented than it was in FIG. 12, because in this embodiment, the patch changes orientation with each selection. The central Gabor patch has lower contrast as well, due to an increase in difficulty after several interactions. Other variables that the software may vary to adjust difficulty may include at least one of: size, contrast level, and orientation.

FIG. 14 shows a depiction of the Gabor patch Contrast Sensitivity Function exercise of FIGS. 12 and 13 after several incorrect user interactions. After several incorrect user interactions, the exercise may adjust its approach toward the user. One method of adjusting its approach, as depicted in FIG. 14, is to reset the contrast back to its highest point, but to increase the internal pattern frequency of the Gabor patches. Through multiple iterations of such testing, the software used by the invention may adapt to the limits of the user's senses regarding both contrast and frequent perception. In an alternative embodiment, other variables that the software may vary to adjust its approach may include at least one of: size, contrast level, and orientation.

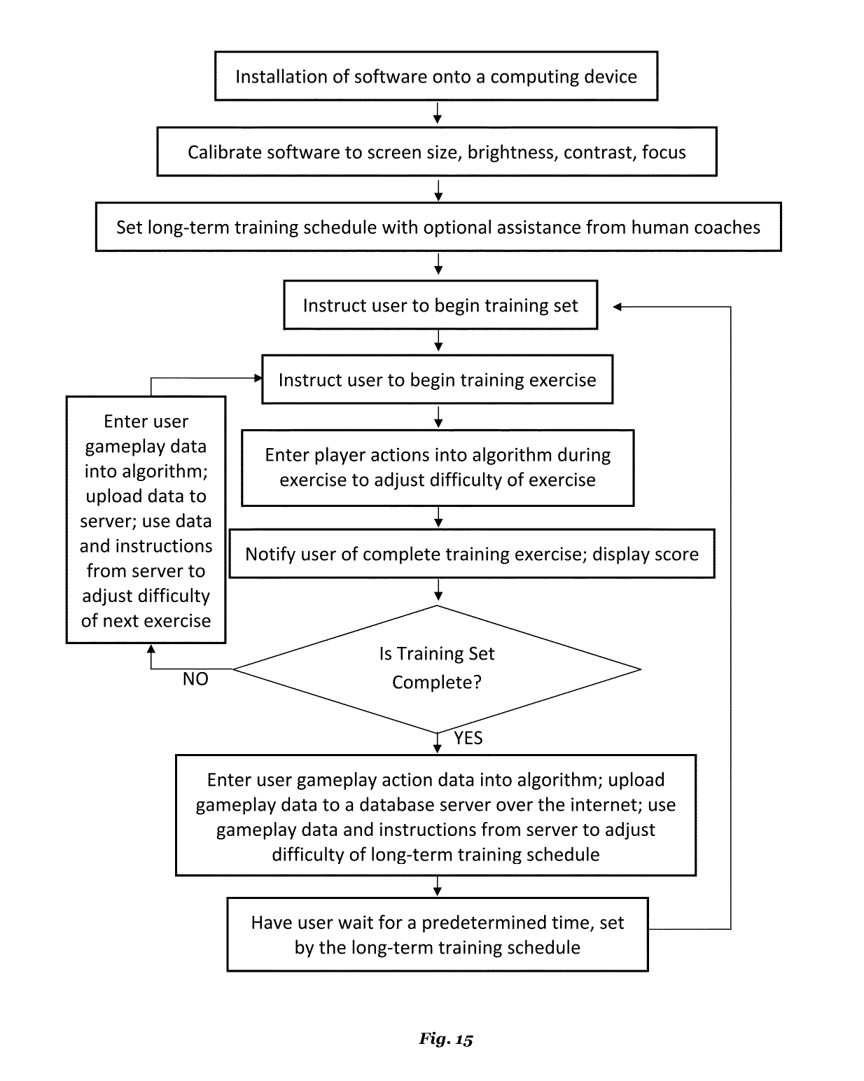

FIG. 15 depicts a flow chart illustrating one embodiment of the invention. As depicted in the flow chart, the invention must first be installed on a computing device with a program processor and calibrated to the display screen. This calibration may take into account the size, contrast, brightness, focus with respect to distance, viewing angle, and any other variable that may modify a user's experience viewing the display screen.

The invention then sets a long-term training schedule. This schedule may be set entirely within the software, through the user filling out a questionnaire, or otherwise selecting ailments or treatment focuses. The schedule may also receive input from human coaches, either in-person or via data sent from the internet in response to an upload of the user's data to a database server. Alternatively, the long-term training schedule may be set algorithmically, by varying training parameters in response to user results generated during a training session.

The user may then be instructed to begin a training set. The training set is comprised of a predetermined number of training exercises. This predetermined number may be set in the long-term schedule, or may be updated by the adaptive algorithm used by the invention.

The user may then be instructed to begin a training exercise. The training exercise may resemble any of the exercises depicted in the previous figures, or any other video game style visual perception or acuity test. During game play, the software stores data about the user's game play performance in a non-transitory computer-readable medium. Alternatively, the user's game play performance may also be uploaded, via the internet, to a non-transitory computer-readable medium on a database server.

During each training exercise, the invention's adaptive algorithm may be used to adjust the difficulty of the exercise in real-time. This adaptive algorithm functions similarly to the adaptive algorithm used by adaptive examination software, such as that used in the GRE exam. In another preferred embodiment, the algorithm uses the “stair-step” method well known in the art. The adaptive algorithm may use a user's game play performance data as it comes in to adjust the difficulty of an exercise in real-time. For example, if a user is chronically slow to find and select Gabor patches in a dynamic Gabor patch exercise, the adaptive algorithm may decrease the predetermined time period that precedes an alert animation or audio cue that alerts the user to the location of a Gabor patch. Inversely, if the user has been performing exceptionally well at such exercises, the adaptive algorithm may increase the time before these alert animations and audio cues. The adaptive algorithm may also introduce distracters, make the distracters more difficult to distinguish from the Gabor patches, or may remove distracters based on user performance. The adaptive algorithm may also adjust penalties for incorrect selections, such as a selection by the user of a distracter, or selection by the user of an incorrect direction in a Landolt C assessment exercise. The adaptive algorithm may also adjust multipliers for quick selections, as in a dynamic Gabor patch exercise.

After each training exercise, the software may either continue to the next exercise in the training set, or, if the training set is complete, may notify the user that the training set is complete. Upon the completion of a training set, the user may then be notified of the next time he or she ought to complete another training set. The next time the user ought to complete another training set is a predetermined number set by the long-term schedule. The user may exit the software at this time, and wait for the next time that he or she ought to complete another training set.

In some cases, it may be desirable to adjust the user's long-term schedule. This may include adjusting the predetermined number of training exercises per training set, adjusting the predetermined amount of time that a user ought to take between training exercises, adjusting the general difficulty level of a certain type of training exercise, or adjusting any other parameter of the user's experience.

The individual training exercises may also produce a score for the user. In some embodiments, this score may be uploaded via the internet to a database server, and displayed to the user or a website as part of a high score list. Alternatively, an interface may be provided wherein scores may be shared by users over social media websites. In some embodiments, scores may be provided representing a user's long-term or average performance on a specific type of training exercise, or representing a user's overall training performance, or representing the improvement of a user's eyesight acuity and perception according to a Snellen visual acuity test or other similar neutral vision test.

In yet further embodiments, the user's score is also accompanied by graphs or charts that display and summarize the user's data over multiple sessions. For example only, and not by way of limiting the invention, graphs could be displayed that summarize the user's scores over time, average time to click per session, accuracy scores per session, or any other data tracked by the invention.

In a preferred embodiment, the software algorithmically determines what to show the user at any moment by combining online performance metrics of the user (e.g. accuracy and reaction time in selecting each stimulus) with algorithms, and scheduling parameters that guide how future stimuli should be displayed based upon that performance. These training session parameters include, but are not limited to, the number of training exercises in a training session, the types of training exercises in a training session, the difficulty ramp of Gabor patches, distractors or other visual designs well known in the art, the speed at which Gabor patches, distractors, or other visual designs appear and disappear, attributes of targets (size, orientation, spatial frequency, contrast, timing), attributes of distracters (type, size, contrast, number, flicker), and level type (static, dynamic). Furthermore, manual customization of all game elements through the scheduler allows for alteration of the scheduling parameters for setting a long-term schedule. The scheduling parameters can include, but are not limited to, the number of training exercises in a training session, the types of training exercises in a training session, the difficulty ramp of Gabor patches, distractors or other visual designs well known in the art, the speed at which Gabor patches, distractors, or other visual designs appear and disappear, attributes of targets (size, orientation, spatial frequency, contrast, timing, adaptive parameters), attributes of distracters (type, size, contrast, number, flicker), level type (static, dynamic), description, instructions, help text, passing criteria, number of repetitions, duration of sessions and each exercise, and game play characteristics ( teleporting or disappearing objects). These allow for both automatic and manual customization of game-play to fit specialized needs of users.

While the foregoing has been exemplary of the invention, other embodiments will occur to those skilled in the art. Accordingly the scope of the invention should be limited only by the scope of the claims appended below.

1. A method to improve perceptual visual skills in a user, comprising the steps of:
exposing the user to a computer program comprising one or more visual training exercises stored on computer storage and executed by a computer processor;
whereby the user interacts with said training exercises using interaction hardware connected to a computing device; such that the interaction indicates whether the user was correctly able to perceive visual stimulus during a training exercise.

2. The method of claim 1, further comprising the step of grouping said training exercises into a training set.

3. The method of claim 2, further comprising the step of adaptively modifying parameters of said training exercises in response to user inputs.

4. The method of claim 3, further comprising the step of setting a long-term schedule to direct a user to return to computer software and perform another training set.

5. The method of claim 4, further comprising the step of setting the long-term schedule by a human coach interacting directly with said computer software and modifying scheduling parameters.

6. The method of claim 4, further comprising the step of setting the long-term schedule by user data being sent over the internet to a database server accessible to a human coach, who may then adjust the user's schedule by modifying scheduling parameters via data sent over the internet by a computerized device used by said human coach.

7. The method of claim 4, further comprising the step of setting said long-term schedule, wherein the user provides personal data, and said computer software uses said personal data to modify scheduling parameters and create a personalized long-term schedule.

8. The method of claim 4, further comprising the step of setting the long-term schedule entirely by said computer software.

9. The method of claim 1, further comprising the step of undertaking a training exercise involving user recognition and selection or matching of Gabor patches.

10. The method of claim 1, further comprising the step of undertaking a training exercise involving user recognition and selection of the orientation of one or more Landolt C designs.

11. The method of claim 1, further comprising the step of utilizing an adaptive algorithm to adjust exercise difficulty based on user performance.

12. The method of claim 10, further comprising the step of utilizing an adaptive algorithm to introduce or alter distractor elements that a user may be penalized for selecting.

13. The method of claim 12, further comprising the step of utilizing an adaptive algorithm to adjust exercise difficulty by modifying training parameters based on user performance.

14. The method of claim 13, further comprising the step of utilizing an adaptive algorithm to set a long-term schedule by varying one or more scheduling parameters.

15. A method of improving perceptual visual skills in a user, comprising the steps of:
Providing a user with a display screen, input device, computer processor and storage medium;
Storing Gabor patches, distractors, and instructions for generating training exercises and sessions on said storage medium;
Providing a first training exercise to the user by projecting one or more Gabor patches and one or more distractors on said display screen;
Capturing the input of said user using said input device, said computer processor and said storage medium;
Adaptively providing additional testing exercises in response to said input by modifying training parameters in response to user inputs to provide a training session;
Capturing said training session input of said user using said input device, said computer processor and said storage medium during said training session; and
adaptively creating a long-term training schedule based on said captured training session input by altering scheduling parameters.
